(19) United States
(12) Patent Application Publication
(10) Pub. No.: US 2008/0215613 A1
(43) Pub. Date: Sep. 4, 2008

(54) Method and System For Transferring Objects Between Programming Platforms Computer Program Product Thereof

(76) Inventor: Ennio Grasso, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/568,389

(22) PCT Filed: Aug. 29, 2003
(86) PCT No.: PCT/EP03/09593

§ 371 Date: Feb. 15, 2006

(51) Int. Cl. G06F 17/30

(52) U.S. Cl. 707/103 R; 707/E17.001

(57) ABSTRACT

Objects are transferred between a first and a second platform, the platforms being, e.g. Java and Net platforms, providing a reflection framework adapted to allow introspection of the meta-information that describes the structure of the objects. The arrangement provides for translating the objects to be transferred into XML payloads by reading the characteristics of the objects through the reflection framework, thereby carrying out introspection of the meta-information that describes the structure of the classes of the objects. The objects translated into XML payloads are transferred from the first to the second platform by means of an asynchronous peer-to-peer delivery facility, such as TCP or UDP. The objects transferred as XML payloads to the second platform are then re-translated into objects of the second platform.

### FIELD OF THE INVENTION

The present invention relates to techniques for passing objects between heterogeneous languages and systems, and was developed by paying specific attention to the possible application in passing objects by value between different platforms such as Java and .Net. Reference to this presently preferred application of the invention is not however to be construed in a limiting sense of the scope of the invention: as better detailed in the following, the invention is generally adapted for use in transfer using objects between any of a pair of introspective programming platforms.

### DESCRIPTION OF THE RELATED ART

In the description of the related art that follows, reference will be repeatedly made to commercial designations constituting trademarks, either registered or having applications for registration pending. The trademark nature of those designations is hereby preliminarily acknowledged in order to avoid repeated acknowledgements.

Today two software platforms are dominating the information technology (IT) world, namely the Java platform championed by SUN Microsystems and backed by many other vendors, and the .Net platform supported by Microsoft.

Java is enjoying a great deal of success on the server side due to its availability for practically any operating systems. Organizations and companies are particularly attracted by the wide range of software solutions and server containers proposed by vendors thus shunning the dreaded vendor lock-in problem and at the same time maintaining interoperability and portability of applications.

Microsoft's .Net is a proprietary platform available on Windows only and from one single vendor. Although .Net is a later comer than Java, its sound technology and the undeniable prowess of its proponent are making .Net a valid competitor that Java supporters have to reckon with.

Recent studies and reports are suggesting that for the foreseeable future neither of these two platforms will monopolize the market. Therefore, the idea of living in a heterogeneous environment has to be accepted particularly by middle sized and large organizations where both systems must be able to coexist and communicate with each other.

Of the many aspects covered by both Java and .Net in their respective frameworks, one element deals with the models and mechanisms that allow remote communications between different processes. These models and mechanisms together represent what is normally called an ORB (Object Request Broker), i.e. a middleware layer that enables remote parties to communicate over the network by exchanging messages. What makes an ORB different from a mere network protocol, which defines the format and semantics of the messages, is that the interface the ORB provides to the application developer is seamlessly integrated in the language through a set of application programming interfaces (APIs) and classes so as to make remote communications appear almost like local communications (objects in the same address space).

The ORB abstracts away from the application all the details related to the translation of parameters into network messages and then again into arguments at the other side of the channel (marshaling/unmarshaling). The ORB also provides naming mechanisms and addressing schemes that make transparent the physical location of the communicating parties and ease the look up and connection process to remote objects.

Both Java and .Net come with their own ORB technology. Java provides RMI (Remote Method Invocation) and .Net has .Net-Remoting. Taken per se RMI and .Net-Remoting cannot interoperate with each other as they employ proprietary binary protocols.

A solution to the interoperability problem between Java and .Net is provided by SOAP (Simple Object Access Protocol). SOAP is a W3C standard protocol based on XML (extensible Modeling Language) and supported by Microsoft, SUN, IBM and many others and conceived for interoperation since its inception. SOAP is the underlying technology of a wide gamut of standards, concepts and specifications that together define what are known as “Web Services”.

SOAP uses HTTP (Hyper Text Transfer Protocol) as a transport protocol and messages are XML payloads encoded in the body of HTTP POST invocations. The choice of HTTP was made in order to address the problems related to firewalls in corporate networks. Web Services were primarily conceived to enable communication between applications in different corporate domains, which are normally protected by firewalls. Firewalls are typically configured to enable HTTP traffic, which explains the decision of making SOAP an HTTP based protocol.

While exhibiting essential assets, HTTP suffers from performance issues that stem from both the nature of the protocol and the complexity of the infrastructure.

Firstly, HTTP is connection-less. In an HTTP transaction, the client sets up a TCP (Transfer Control Protocol) connection, sends a request to the server, waits for the response and then releases the connection. The computational process required to set up and release TCP connections is costly and should be avoided as much as possible. HTTP 1.1 introduced the concept of permanent connections whereby the same TCP connection can be reused to convey several HTTP transactions as parts of the same client/server dialog: no guarantee however exists that the dialog will occur over the same underlying TCP connection. The absence of such a guarantee requires the definition of a mechanism to relate different HTTP messages as parts of the same dialog or, in HTTP parlance, the same session.

Secondly, the HTTP model of communication is synchronous and blocking. As explained in the foregoing, the client sends the request and then blocks, waiting for the response from the server. This client/server communication model is satisfactory in several situations; in other circumstances a different communication model may be desirable, particularly when the communicating parties are peers in a dialog. In the peer-to-peer (P2P) model, communication is asynchronous and non-blocking. Each peer sends a message to the other peer and continues its normal computation. If the need arises for the other peer to send a response, it will do so with an asynchronous message. The P2P non-blocking nature of asynchronous messages also enables unsolicited notifications, i.e. messages to notify the occurrence of certain events of interest. Generally speaking, the P2P model is more flexible and performing than the client/server model. While a client/server communication can be simulated in a P2P model the converse will not apply. Implementing an asynchronous non-blocking mode over a synchronous transport is not feasible and therefore P2P cannot be achieved over HTTP. Conversely, TCP is intrinsically asynchronous and is the preferred choice for a P2P style of communication.

Thirdly, HTTP requires an application server. Whilst an ORB middleware typically comes in the form of a library or framework that is to be embedded within the application, HTTP requires a separate application server that acts as a container for the real application. The application server mediates all HTTP communications and manages computational and network resources. This shielding of the application from computational and network resources comes at the expense of a more complex configuration, deployment, and management environment and also reduces performance due to the higher complexity of the system.

Turning back to the SOAP protocol, although the ‘S’ stands for ‘Simple’, SOAP is anything but a simple protocol. SOAP's XML payloads are complex and bulky because even the simplest message contains big chunks of meta-data.

Web Services interfaces are defined in WSDL (Web Service Description Language), another XML-based language which is relatively complex and bloated. Java and .Net implementations of the SOAP protocol provide compilers that translate WSDL interfaces into classes and interfaces in Java or VisualBasic/C#. But the great complexity for setting up a SOAP communication defeats the purpose of an ORB in the first place, which was to facilitate coding by an application developer.

In WO-A-02/101579 a system and a method are disclosed translating software objects into XML documents and vice versa. The translation to and from Java and XML is carried out through an XML2xMappingImp1 class that “knows” how to map the XML elements of the document into the properties of the Java object. There must be one XML2xMappingImp1 for each Java class since each class will be structurally different. For instance, WO-A-02/101579 describes an example, designated XML2CustomerMappingImp1, which specializes in mapping XML into the properties of a Customer Java object class. Likewise, there must be an X2XMLMappingImp1 for mapping from the input Java object to the output XML document. For example a Customer2XMLMappingImp1 for the Customer class. Therefore the approach of WO-A-02/101579 is based on a static mapping that requires the generation of specialized mapping classes for each Java class that needs to be mapped into XML.

In WO-A-01/086427 and the documents belonging to the same family, an arrangement is disclosed for compiling software objects into XML and decompiling XML into objects. Specifically, the Java Virtual Machine (JVM) is suggested to be extended for compiling objects into XML and vice versa. Embedding the compilation/decompilation process within the JVM is shown to expedite the process and require a smaller footprint compared with an approach that employs reflection. Additionally, the translation process of WO-A-01/086427 employs an intermediary hash table where each entry key is the name of an instance variable of the object's class (property-name) and each entry value is the value of said instance variable (property-value).

### OBJECTS AND SUMMARY OF THE INVENTION

While the problem of ensuring conversion of the conventions used in different platforms such as Java and .Net so as to allow communication and exchange of data content between them has been fully solved in the past (and is not specifically catered for by this invention), the need is still felt for an ORB that may meet the following requirements:
like SOAP, it should support communication between Java and .Net using XML. XML is the lingua franca for today's communicating systems and the great availability of tools and parsers makes it the most reasonable choice. While a binary protocol may in principle be more efficient and space saving, a well designed XML protocol that limits or even avoids meta-data represents a viable solution;
it should allow peer-to-peer (P2P) asynchronous non-blocking communications. As demonstrated in the foregoing, being based on HTTP, SOAP is synchronous, blocking and tailored for client/server communications. The P2P model cannot be delivered over HTTP;
it should provide few simple and sound concepts, easy to understand and comply with. The impedance mismatch between local communications and remote communications should be reduced inasmuch as possible. Developers should be able to set up a communication and exchange messages with very few calls to the ORB and deal with the concept that is most familiar to them: objects. The ORB should be the enabler that allows exchanging objects between remote peers.

The object of the present invention is thus to meet the need outlined in the foregoing.

According to the present invention, that object is achieved by means of a method having the features set forth in the claims that follows. The invention also relates to a corresponding system as well as a computer program product loadable in the memory of at least one computer and including software code portions for performing the steps of the method of the invention when the product is run on at least one computer. Reference to “at least one computer” is evidently intended to highlight the possibility for the method of the invention to be carried out in a decentralized manner over a plurality of machines.

A preferred embodiment of the present invention is an ORB (Object Request Broker) that relies on XML and allows communication between Java and .Net applications, between Java applications, and between .Net applications. Messages are delivered according to the P2P asynchronous non-blocking style of communication e.g. over TCP. A message between remote peers can be any Java or .Net object. The ORB will marshal the object into an XML payload, deliver it to the other peer and then unmarshal the payload into an object again. Such an arrangement will implement a pass-by-value semantics for objects between remote peers, possibly implemented in different languages and systems.

In comparison, e.g. the arrangement disclosed in WO-A-02/101579, the mapping approach proposed herein is dynamic. Instead of depending on specialized mapping classes, it exploits the reflection framework of Java and .Net (and other platform) to dynamically inspect the names and values of all the properties of any given class.

In one embodiment the ORB disclosed herein consists of two major components, a translator component and a network component. The translator is the component responsible for translating objects into XML payloads and vice versa through a mechanism called reflection. Both Java and .Net provide a reflection framework that allows runtime introspection of the meta-information that describes the structure of any object's class. What fields, properties, and methods the class supports, what their types are and the types of their arguments. Therefore, present invention is applicable to any language and system that provides support for a reflection framework.

In comparison with the arrangement disclosed in WO-A-01/086427, the present invention does not rely on an intermediary table; rather, the translator component reads the elements of the XML payload and through reflection directly assigns their values to the properties of the object. Likewise, the translator reads the properties value of the objects and directly generates the matching XML elements.

### BRIEF DESCRIPTION OF THE ANNEXED DRAWINGS

The invention will now be described, by way of example only, by referring to the enclosed figures of drawing, wherein:

FIGS. 1 and 2 are flow charts exemplary of operation of certain elements of the arrangement disclosed herein,

FIG. 3 is another flow chart exemplary of peer-to-peer communication within the framework of the arrangement described herein,

FIG. 4 details generation of XML payloads starting from a Java object within the framework of the arrangement described herein,

FIG. 5 schematically represents generation of a Java object from XML payload within the framework of the arrangement disclosed herein,

FIGS. 6 to 8 further details processing steps performed within the framework of the arrangement disclosed herein, and

FIG. 9 is a functional block diagram depicting a typical scenario of application of the arrangement disclosed herein.

### DETAILED DESCRIPTION OF PREFERRED EMBODIMENTS OF THE INVENTION

FIG. 1 illustrates the general steps performed by the XmlObjectWriter (i.e. the part of a translator that transforms any given object into XML) to transform an object into an XML payload.

In a step 101 the XML start document is written using the name of the object's class or a different name if one is supplied by the application.

In a subsequent step 102 the system inspects through reflection the object's class meta-information and reads all the public properties names and values.

In a subsequent selection step 1000 the type of property considered is identified as being a basic type, an object type, or an array type.

For any property that is a basic type (int, char, float, boolean, etc.) in a step 103 an XML element is written whose name is the property name and value is the property value.

For example a class:

class TheClass {

public int age 36;
public String name = “John”;

}

is translated into:

<TheClass>

<age>36</age>
<name>John</name>

</TheClass>

In a step 104, for any property that is a complex type, i.e. the property type is itself an object, the object is transformed with a recursive call to the XMLObjectWriter in step 102 producing a nested XML complex element.

For example, given a class TheClass that has a property of type TheClass2;

class TheClass {

public int age 36;
public String name = “John”;
public TheClass2 nest = new TheClass2( );

}
class TheClass2 {

public boolean isCorrect = true;
public float salary = 1.234;

}

is translated into:

<TheClass>

<age>36</age>
<name>John</name>
<nest>

<isCorrect>true</isCorrect>
<salary>1.234</salary>

</nest>

</TheClass>

In a step 105 for any property that is an array or an indexed property (indexed properties are Java Bean equivalent of arrays), the sequence of the array's elements is written; e.g.

class TheClass {

public int age 36;
public String name = “John”;
public int[ ] array = {0, 1, 2};

}

gives:

<TheClass>

<age>36</age>
<name>John</name>
<array>0<array>
<array>1<array>
<array>2<array>

</TheClass>

The XmlObjectWriter is also able to translate cyclic object graphs. To this end each XML element that represents an object type is given a unique “id” attribute value. If a cycle is detected, i.e. the same object is encountered for the second time during the transformation process, an empty element with an “idref” attribute is written out with the same value of the “id” attribute of the already transformed object. For example, given TheClass that refers to TheClass2, which itself refers to TheClass:

class TheClass {

public int age 36;
public String name = “John”;
public TheClass2 nest = new

TheClass2(this);

}
class TheClass2 {

public boolean isCorrect = true;
public float salary = 1.234;
public TheClass tc;
public TheClass2(TheClass tc) {

this.tc = tc;

}

}

will produce the following XML:

<TheClass id=”1”>

<age>36</age>
<name>John</name>
<nest id=”2”>

<isCorrect>true</isCorrect>
<salary>1.234</salary>
<tc idref=”1”/>

</nest>

</TheClass>

The XmlObjectReader is the element of the translator that, given an XML payload from an input stream instantiates an object and fills its public properties with the values contained in the XML payload. The XmlObjectReader uses an XML parser to parse the XML payload.

Java parsers typically support the SAX (Simple API for XML) specification that employs a push-model. The application registers a content handler that will receive events fired by the parser whenever a start element, end element, or content are parsed. The Java embodiment of the XmlObjectReader relies on a SAX parser.

Conversely, the .Net framework provides a parser that employs the pull-model where the parsing process is driven by the application. The .Net embodiment of the XmlObjectReader relies on the .Net pull parser.

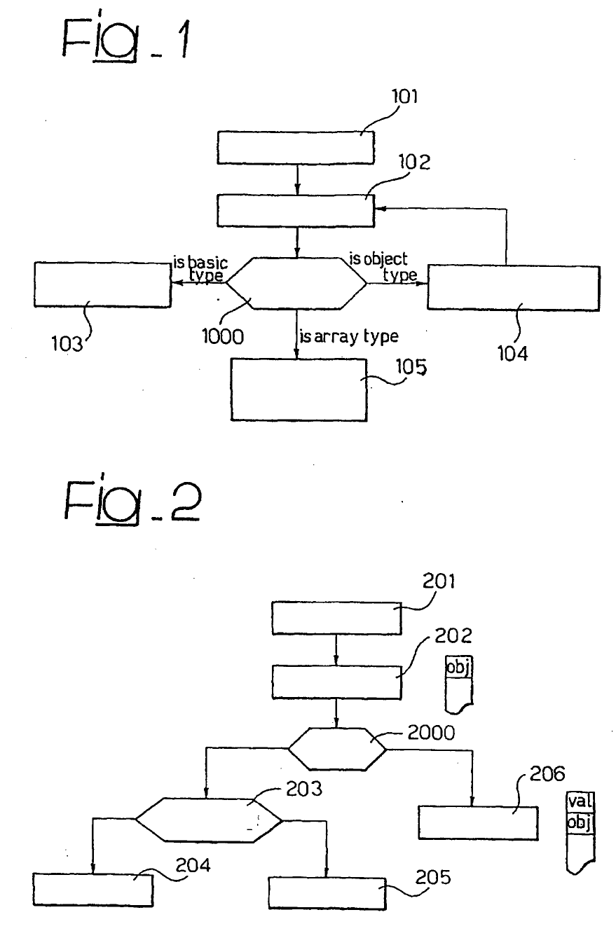

FIG. 2 illustrates the general steps performed by the XmlObjectReader to transform an XML payload into an object.

In a step 201 the document name of the XML payload is retrieved. If a ClassResolver has been registered with the XmlObjectReader that ClassResolver is invoked by passing the document name as input and obtaining a class name as result. The ClassResolver is a component that the application can supply to decide the mapping between the class name and the document root name. If no ClassResolver is registered the XmlObjectReader assumes that the element root is indeed the class name.

In a step 202, the system creates through reflection an instance of an object whose class name has been determined in step 201 and pushes this instance on top of a stack.

In a step 2000 the next XML element is parsed and in a step 203 if the parser detects a start element in the XML payload, the object at the top of the stack is inspected through reflection and the type of the property whose name is the name of the given XML start element is determined. For example, if the start element is “age”

<age>22</age>

and at the top of the stack there is an object of class TheClass, then its “age” property is inspected and determined being of type int:

```
TheClass {
    int age;
    ...
}
```

In a step 204, if the property type is a basic type (int, char, float, boolean, etc.) the content of the XML element is read and pushed on the stack. In the example above the string “22” is pushed on the stack.

If the type is a complex type, i.e. an object, in a step 205 an instance of this object is created and pushed on the stack and its properties will be read and assigned recursively going to step 2000.

If the type is an array or indexed property, the type of its elements is determined and either step 204 or step 205 will apply.

If the parser detects an end element, then the top of the stack contains the value that was pushed when the start element was encountered. In a step 206 this value is popped from the stack and the object presently at the top of the stack is inspected through reflection to determine the type of the property whose name is the name of the given XML end element.

If the property is a basic type, the value popped is a string (see step 204) that is converted to the type of the property and assigned to it. For example, the string “22” is converted to int and assigned to the property “age”.

If the property is a complex type, the value popped is an object and assigned to the property.

Lastly, if the property is an array or indexed property, the value popped is an element of the array and is assigned at the next unassigned index. In other words, the first value is assigned at index 0, the next at index 1, etc.

The parsing process is continued in a recursive manner until the end of the document is reached. At that point the stack will contain only one object representing the result of the transformation of the XML payload. This object is returned to the application.

To deal with cyclic object graphs, the XmlObjectReader reconstructs a cycle as encoded by the XmlObjectWriter. When parsing a complex element with an “id” attribute, the object instantiated corresponding to that element (in step 202) is saved on a hash table using the “id” value as hash-key. If later the parser finds an element with an “idref” attribute, the object that that element represents is the one saved in the hash table and retrieved using the “idref” value as key.

The network components of the arrangement described herein basically consists of two classes, Acceptor and a Connector. The Acceptor creates a listening socket and waits for incoming connections. A Connector (see also references 34 and 24 in FIG. 9, to be described later) represents a TCP connection and is ether explicitly instantiated by specifying the URL of the remote peer, e.g.

Connector c=new Connector(“xmltcp://host.com:1234/”);

or as a side effect of the Acceptor receiving a connection request from another peer. A single Acceptor may create any number of independent Connectors as result of different connection requests on its port.

The application can be notified when connections are set up and torn down by registering listeners with the Acceptor and Connector. By registering a ConnectionListener with the Connector, the application will receive a connectionStarted event and connectionEnded event respectively.

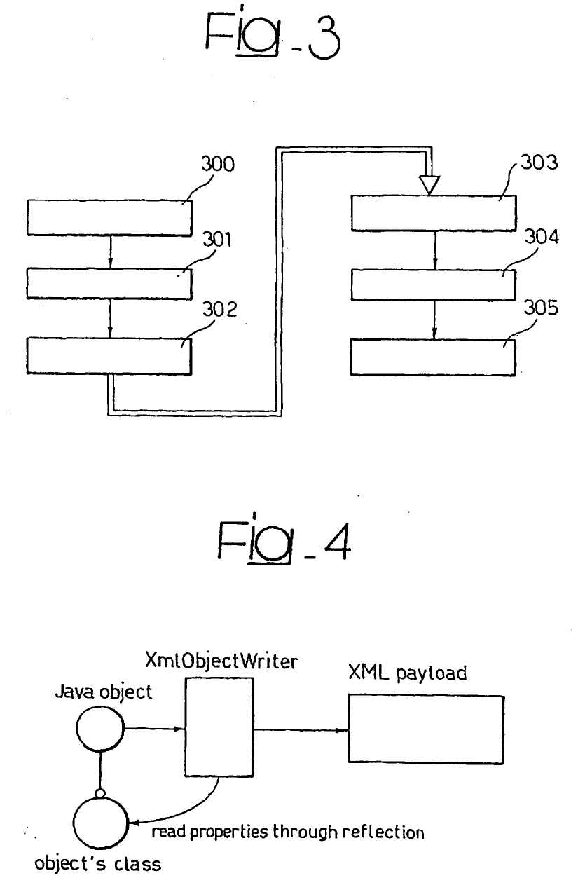

With reference to FIG. 3, objects are sent from a “local” peer (peer 1) to a “remote” peer (peer 2) simply by calling the sendObject method of the Connector and passing the object to be sent as argument (step 300). The Connector internally uses an XmlObjectWriter to transform the object into an XML payload (step 301) and write the payload on the socket's output stream (step 302). The invocation is asynchronous and non-blocking. At the other side of the TCP connection the peer Connector receives the XML payload (step 303) and uses an XmlObjectReader to convert the payload into an object again (step 304). At that point the Connector notifies (step 305) the application of the received object through a receiveObject event delivered to a listener class in the Java embodiment or through a delegate in the C# embodiment for the NET platform.

The Java and C# classes of the objects that are passed between the two peers are required to be compatible, that is their public properties have the same names and types. During unmarshaling the XmlObjectReader will make a best effort to try and match the properties by leaving unaltered (not initialized) those properties whose names do not match the elements' names in the XML payload.

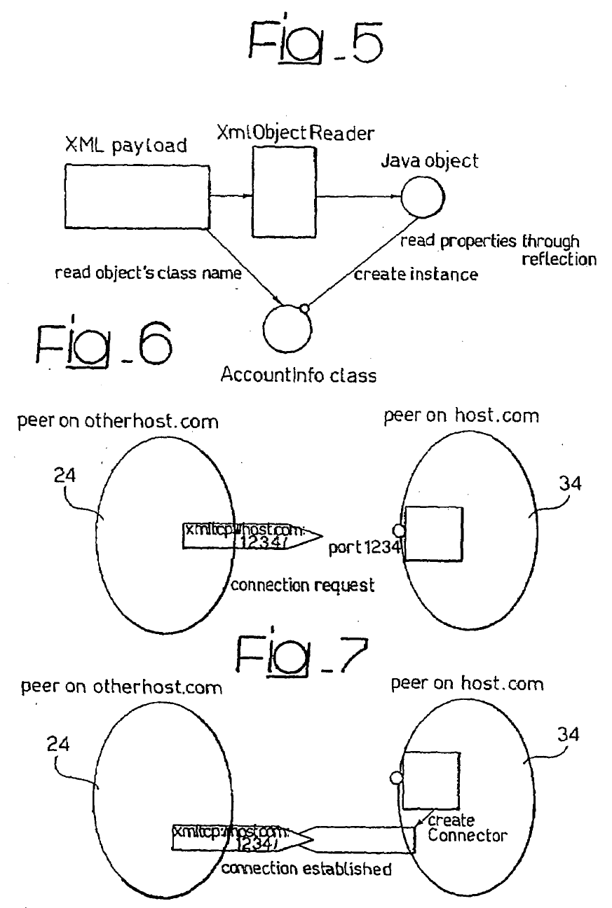

FIGS. 4 and 5 schematically represent, respectively:
the generation of XML payload starting from a Java object, and
generation of a Java object from XML payload as better detailed in the foregoing.

In order to ensure fully satisfactory performance, the connector's architecture does not rely on a one-to-one relationship between sockets and threads of execution. In a one-to-one relation each connection is assigned to a thread responsible for serving the connection for its entire lifetime. For I/O bound applications, the ratio between the time spent waiting for incoming requests and the time spent carrying out the requested operation is usually high. This means that the thread spends most of its time waiting rather than working, whereby the one-to-one relationship is a waste of thread resources. A person skilled in the art knows that threads are precious computational resources and must be used sparingly. A preferred approach is thus to have one master thread listening for incoming requests on all the allocated connections. If data become available on any of the connections, the master thread dispatches the incoming request to a worker thread from a pre-allocated pool.

For versions of Java up to 1.3 the one-to-one thread/connection relationship was the only option because a read operation on a socket blocks the calling thread until data is available. With Java version 1.4 the NIO (New I/O) package was introduced that lets asynchronous non-blocking socket operations allowing a single thread to listen for data on many connections simultaneously.

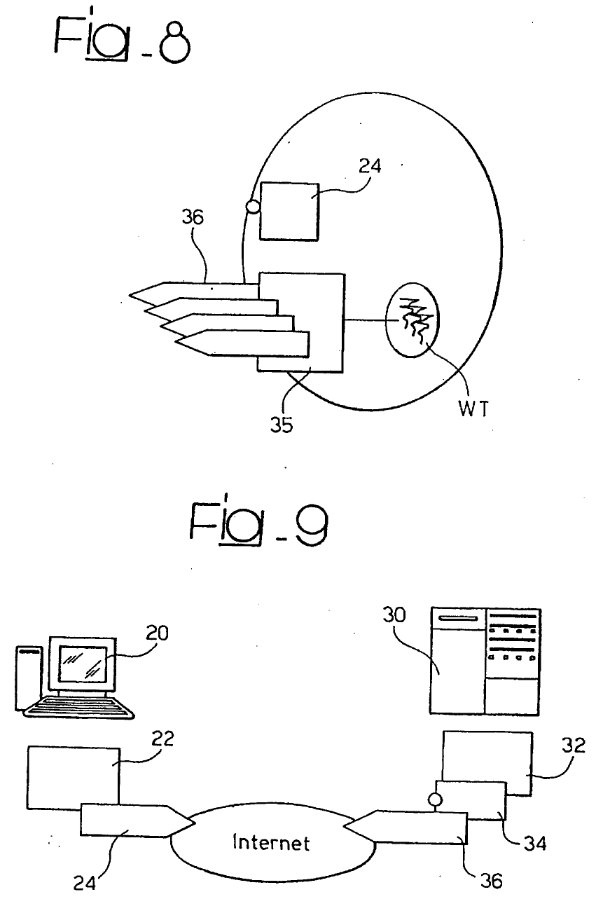

A preferred embodiment of the arrangement described herein exploits the Java NIO framework with one master thread serving several connections and then dispatching each incoming request to a worker thread. Besides the Acceptor 34 and Connector 24 (intended to co-operate in managing a connection request and establish connection as shown in FIGS. 6 and 7), the Java embodiment introduces a Reactor 35 that decouples the Connectors, which indeed represent TCP connections, from the pool of worker threads WT that carry out the requested operations. As schematically shown in FIG. 8, a single Reactor 35 can manage any number of Connectors 36.

The Reactor's main logic is a continuous loop where the master thread:
waits for any events occurring at any of the connections.
when a read event occurs for a certain connection (which means that data have become available) takes a worker thread from the pool and binds it to the Connector to carry out the reading, parsing, and dispatching as described previously;
when a write event occurs for a certain connection (which means that data can be written to the connection without blocking the writing thread) takes a worker thread from the pool and binds it to the Connector to carry out the marshaling and writing process as described previously.

The Java and .Net embodiments of the proposed invention are architecturally equivalent but differ in respect of certain details that take into account the specific idioms of each respective language. For example, where Java events are registered in accordance with the “listener” pattern, in C# events are defined with a specific language keyword and tied with the delegates idiom. Also, as mentioned above, there are internal differences on the parsing model of the XML payloads. Finally, the management of the thread/connection relation is different between the two embodiments and is tailored to the features provided by the respective platforms.

FIG. 9 portrays a possible scenario where the arrangement described herein may be exploited.

A personal computer 20 running a Windows operating system with the .Net framework is connected via the Internet to a server UNIX machine 40 that supports a Java platform.

An instant messaging client application 22 runs on personal computer 20. This is an application, written for the .Net platform in C#, that needs to communicate with its server counterpart 32 written in Java running on machine 30.

The communication will be P2P as the client may need to send messages to the server, e.g. to perform buddy search operations or to send a chat message, and some times the server will need to send an unsolicited message to the client, e.g. to relay a chat message from another user.

In this scenario the instant messaging application needs a P2P ORB that allows .Net and Java to communicate over TCP.

The client application 22 creates a Connector 24 using the URL of the server machine, e.g.

Connector c=new Connector(“xmltcp://host.com:1234/”);

then registers a delegate to a local method to be invoked by the Connector on incoming objects from the server

c.ReceiveEvent+=new ReceivedObjectEventHandler(this.Receive);

When the Connector 24 receives an object from the server it will invoke the Receive method of the client application 22.

Conversely, the server side 32 creates an Acceptor 34 and registers itself as connection listener.

Acceptor a=new Acceptor(1234); a.setConnectionListener(this);

When a new Connector 36 is created as a result of a remote client connecting to the Acceptor, the connectionStarted event is fired and the server application 32 can register itself as listener for incoming objects from the client:

public void connectionStarted(Connector c) {
c.setBeanInternalizer(this);
}

The arrangement described is based on a peer-to-peer communication over a TCP connection. Alternative embodiment may utilize, among others, UDP (User Datagram Protocol) packets rather than TCP connections. UDP is a lighter IP protocol that is packet-oriented rather than connection-oriented. UDP is not reliable and order preserving like TCP but may be suitable for applications where a very light protocol is desirable (e.g. for small devices such as smart phones, PDAS, etc.) or when loss of information may be acceptable because the operation is idempotent and periodical (e.g. a message that periodically notifies the current status of an apparatus or system). The XML payloads may thus be written as UDP packets. As the remote peer receives a packet, its content is assumed to be an XML payload to be converted into an object. Such an embodiment will employ a DatagramSender and a DatagramReceiver where the TCP embodiment described in detail in the foregoing employs the Connector 24 and the Acceptor 34.

The Java embodiment described in the foregoing employs a Reactor 35 to decouple the TCP connections and the threads serving them. This model is best suited for scaling a system to serve a high number of concurrent connections. However this embodiment assumes the availability of the Java 1.4 NIO package or equivalent thereof.

If a legacy system requires the use of Java 1.x where x<4, or if the application is not required to serve a high number of concurrent connections, i.e. a peer will only have a limited number concurrently connected peers, then a one-to-one connection/thread relationship may be acceptable. Such an embodiment will simplify the architecture by dispensing with the Reactor and binding each connector to a separate thread.

The arrangement described herein is intended to permit transfer of objects between Java and .Net platforms. Other platforms may also be supported provided the target system supports a reflection framework for the dynamic inspection of the meta-information of an object's class, thus supporting the marshal/unmarshal process of the translator component.

It is thus evident that, the basic principles of the invention remaining the same, the details and embodiments may widely vary with respect to what has been described and illustrated purely by way of example, without departing from the scope of the presented invention as defined in the annexed claims.

### CROSS REFERENCE TO RELATED APPLICATION

This application is a national phase application based on PCT/EP2003/009593, filed Aug. 29, 2003, the content of which is incorporated herein by reference.

1-23. (canceled)

24. A method for transferring objects between a first and a second platform, said platforms providing a reflection framework adapted to allow introspection of the meta-information that describes the structure of said objects, comprising: the step of translating said objects to be transferred into XML payloads by reading the characteristics of said objects through said reflection framework, thereby carrying out introspection of the meta-information that describes the structure of the classes of said objects.

25. The method of claim 24, comprising the step of transferring said objects translated into XML payloads from said first platform to said second platform by means of an asynchronous delivery facility.

26. The method of claim 25, comprising the step of re-translating said objects transferred as XML payloads to said second platform into objects of said second platform.

27. The method of claim 24, wherein said step of translating comprises:
writing a start document;
reading the respective objects properties through said reflection framework;
writing the property name and value if said property is basic type;
writing the property name and calling recursively if said property is object type; and
writing the property name and value of all components if said property is array type.

28. The method of claim 26, wherein said step of re-translating comprises:
resolving a class name from a document name;
creating an object of said second platform and pushing it on a stack; and
either pushing the XML content on stack or pushing a new object on stack after getting the property type of object on stack; or
popping a value and assigning it to a top object.

29. The method of claim 24, comprising the step of selecting at least one of said first and second platforms as a Java platform.

30. The method of claim 24, comprising the step of selecting at least one of said first and second platforms as a .Net platform.

31. The method of claim 25, comprising the step of selecting said asynchronous delivery facility as a peer-to-peer delivery facility.

32. The method of claim 25, comprising the step of selecting TCP as said asynchronous delivery facility.

33. The method of claim 25, comprising the step of selecting UDP as said asynchronous delivery facility.

34. The method of claim 25, comprising the steps of providing in said second platform
at least one connector of said delivery facility as well as a set of worker threads for carrying out the requested operations; and
a reactor function for decoupling said at least one connector from said set of worker threads.

35. A system for transferring objects between a first and a second platform, said platforms providing a reflection framework adapted to allow introspection of the meta-information that describes the structure of said objects, comprising: a translator module configured for translating said objects to be transferred into XML payloads by reading the characteristics of said objects through said reflection framework, thereby carrying out introspection of the meta-information that describes the structure of the classes of said objects.

36. The system of claim 35, comprising an asynchronous delivery facility for transferring said objects translated into XML payloads from said first platform to said second platform.

37. The system of claim 36, comprising a re-translator module configured for re-translating said objects transferred as XML payloads to said second platform into objects of said second platform.

38. The system of claim 35, wherein said translator module is configured for performing the operations of:
writing a start document;
reading the respective objects properties through said reflection framework;
writing the property name and value if said property is basic type,
writing the property name and calling recursively if said property is object type; and
writing the property name and value of all components if said property is array type.

39. The system of claim 37, wherein said re-translator module is configured for performing the operations of:
resolving a class name from a document name;
creating an object of said second platform and pushing it on a stack; and
either pushing the XML content on stack or pushing a new object on stack after getting the property type of object on stack; or
popping a value and assigning it to a top object.

40. The system of claim 35, wherein at least one of said first and second platforms is a Java platform.

41. The system of claim 35, wherein at least one of said first and second platforms is a .Net platform.

42. The system of claim 35, wherein said asynchronous delivery facility is a peer-to-peer delivery facility.

43. The system of claim 35, wherein said asynchronous delivery facility is TCP.

44. The system of claim 35, wherein said asynchronous delivery facility is UDP.

45. The system of claim 35, wherein said second platform comprises:
at least one connector of said delivery facility as well as a set of worker threads for carrying out the requested operations; and
a reactor function for decoupling said at least one connector from said set of worker threads.

46. A computer program product capable of being loaded in the memory of at least one computer and comprising software code portions for performing the steps of the method of any one of claims 24 to 34.
